(19) United States
(12) Patent Application Publication
(10) Pub. No.: US 2024/0267807 A1
(43) Pub. Date: Aug. 8, 2024

(54) METHODS AND APPARATUS OF MAC PARTIAL RESET DURING INTRA-DU LTM

(71) Applicant: MediaTek Singapore Pte. Ltd., Singapore (SG)

(72) Inventors: Yao Peng, Beijing (CN); Xiaonan Zhang, Beijing (CN); Yuanyuan Zhang, Beijing (CN); Shuo Ma, Beijing (CN); Tao Chen, Beijing (CN)

(21) Appl. No.: 18/437,129

(22) Filed: Feb. 8, 2024

Related U.S. Application Data
(63) Continuation of application No. PCT/CN2023/074650, filed on Feb. 6, 2023.

(30) Foreign Application Priority Data
Feb. 6, 2023 (WO) PCT/CN2023/074650
Jan. 22, 2024 (CN) CN 202410088891.4

(51) Int. Cl. H04W 36/04; H04L 1/1812; H04W 36/08; H04W 76/20

(52) U.S. Cl. CPC H04W 36/04; H04L 1/1812; H04W 36/08; H04W 76/20

(57) ABSTRACT

Apparatus and methods are provided for UE performing MAC partial reset during cell switch by LTM. In one novel aspect, the UE performs partial MAC reset by keeping a set of MAC procedures. In another novel aspect, the UE keeps the HARQ process initiated by the source cell for the cell switch by LTM. In one embodiment, the UE associates one or more HARQ entities of the source cell to one or more component carriers (CCs) of the target cell after switching the UE serving cell to the target cell. In one embodiment, the UE obtains association information by receiving association information from the network, or by a linkage between CCs of the source cell group and the target cell group when no SCell changes or the target PCell is a source SCell or by deriving the association information based on the difference of current slot/symbol/SFN.

### CROSS REFERENCE TO RELATED APPLICATIONS

This application is filed under 35 U.S.C. § 111 (a) and is based on and hereby claims priority under 35 U.S.C. § 120 and § 365 (c) from International Application No. PCT/CN2023/074650, titled “METHODS AND APPARATUS OF MAC PARTIAL RESET DURING INTRA-DU LTM,” with an international filing date of Feb. 6, 2023. This application claims priority under 35 U.S.C. § 119 from Chinese Application Number 202410088891.4, titled “PROCEDURE OF CELL CHANGE IN A RADIO SYSTEM,” filed on Jan. 22, 2024. The disclosure of each of the foregoing documents is incorporated herein by reference.

### TECHNICAL FIELD

The disclosed embodiments relate generally to wireless communication, and, more particularly, the method of MAC partial reset during intra-DU LTM.

### BACKGROUND

In the conventional network of the 3rd generation partnership project (3GPP) 5G new radio (NR), when the UE moves from the coverage area of one cell to another cell with better signal quality, at some point a serving cell change needs to be performed. Currently serving cell change is triggered by layer-3 (L3) measurements and is done by radio resource control (RRC) signaling triggered by reconfiguration with synchronization for change of primary serving cell (PCell) and primary SCG (secondary cell group) cell (PSCell), as well as release/add for secondary cells (SCells) when applicable. All cases involve complete L2 (and L1) resets, leading to longer latency, larger overhead, and longer interruption time than beam switch mobility. A further enhancement in 5G NR is the improvement of inter-cell mobility. In order to reduce the latency, overhead, and interruption time during UE mobility, the mobility mechanism can be enhanced to enable a serving cell to change with L1/L2 signaling. The L1/L2 based inter-cell mobility (LTM, L1/L2-triggered Mobility) should support the different scenarios, including intra-DU (distributed unit)/inter-DU inter-cell cell change, frequency range-1 (FR1)/FR2, intra-frequency/inter-frequency, and source and target cells may be synchronized or non-synchronized.

In legacy handover (HO) design controlled by a series of L3 procedures including radio resource management (RRM) measurement and RRC Reconfiguration, ping-pong effects should be avoided with relatively long ToS (time of stay) in order to reduce the occurrences of HOs, accompanied with which is the reduction of signaling overhead and interruption during the overall lifetime of RRC connection. However, the drawback is that UE can't achieve the optimized instantaneous throughput if the best beam does not belong to the serving cell. L1/L2 based inter-cell mobility is more proper for the scenarios of intra-DU and inter-DU cell changes.

Improvements and enhancements are required for cell change procedures.

### SUMMARY

Apparatus and methods are provided for UE performing MAC partial reset during cell switch by LTM. In one novel aspect, the UE performs partial MAC reset by keeping a set of MAC procedures running for the cell switch procedure by LTM. In one embodiment, the set of MAC procedures comprises a logical prioritization procedure, a buffer status reporting procedure, a recommended bit rate query procedure, and a positioning measurement gap activation/deactivation request procedure. In one embodiment, the partial MAC reset is always performed for the cell switch procedure by LTM, triggered by configuration from the wireless network through radio resource control (RRC) message, or triggered by indication in the cell switch command. In another embodiment, the partial MAC rest further comprising stopping an ongoing random access procedure, canceling triggered procedures of a power headroom reporting, canceling triggered beam failure recovery (BFR) procedures, canceling consistent listen-before-talk (LBT) failure procedures.

In another novel aspect, the UE keeps one or more HARQ processes initiated by the source cell for the cell switch by LTM. In one embodiment, a code block/code block group (CB/CBG) of a same transport block (TB) from the source cell and the target cell are associated to a same HARQ process when the UE is configured non-carrier aggregation (non-CA) or when CA is configured and there is no secondary cell (SCell) change for the cell switch procedure. In one embodiment, a TB received from the source cell and the target cell is combined for downlink (DL) HARQ process and no HARQ soft buffer flushing during the cell switch procedure. In another embodiment, the UE keeps a value of new data indication (NDI) of an uplink (UL) HARQ process during the cell switch procedure. In one embodiment, the UE associates one or more HARQ entities of the source cell to one or more component carriers (CCs) of the target cell after switching the UE serving cell to the target cell. In one embodiment, the UE obtains association information by receiving association information from the network. In another embodiment, the UE derives association information based on the difference of current slot/symbol/SFN. In yet another embodiment, the association information is a linkage between CCs of the source cell group and the target cell group when no SCell changes or the target PCell is a source SCell, and wherein the UE associates one or more HARQ entities to corresponding target CCs based on the linkage.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1A is a schematic system diagram illustrating an exemplary wireless network with MAC partial reset during intra-DU LTM in accordance with embodiments of the current invention.

FIG. 1B illustrates an exemplary UE and base station for MAC partial reset during intra-Du LTM in accordance with embodiments of the current invention.

FIG. 2 illustrates an exemplary wireless system with centralized upper layers of the NR radio interface stacks in accordance with embodiments of the current invention.

FIG. 3 illustrates an exemplary deployment scenario for intra-DU LTM in accordance with embodiments of the current invention.

FIG. 4 illustrates exemplary diagrams of intra-DU cell switch during LTM for UE to keep certain MAC functions ongoing in accordance with embodiments of the current invention.

FIG. 5 illustrates exemplary diagrams of intra-DU cell switch by LTM for the UE to stop certain MAC functions and cancel the corresponding procedures in accordance with embodiments of the current invention.

FIG. 6 illustrates exemplary diagrams for keeping the HARQ process for cell switch by LTM in non-CA scenario in accordance with embodiments of the current invention.

FIG. 7 illustrates exemplary diagrams for keeping the HARQ process for CA scenario of the cell switch when the PCell changes without SCell changes in accordance with embodiments of the current invention.

FIG. 8 illustrates exemplary diagrams for the UE to obtain association information in the CA scenario of the cell switch by LTM when the target PCell/target SCell (s) is not a current serving cell in accordance with embodiments.

FIG. 9A illustrates exemplary diagrams of the UE keeps the CC and HARQ entity association in the CA scenario of the cell switch when the target PCell is a current SCell with equal component carriers in accordance with embodiments of the current invention.

FIG. 9B illustrates exemplary diagrams of the UE keeps the CC and HARQ entity association in the CA scenario of the cell switch when the target PCell is a current SCell with fewer component carriers in the target cell in accordance with embodiments of the current invention.

FIG. 9C illustrates exemplary diagrams of the UE keeps the CC and HARQ entity association in the CA scenario of the cell switch when the target PCell is a current SCell with more component carriers in the target cell in accordance with embodiments of the current invention.

FIG. 10 illustrates an exemplary flow diagram for UE to perform HARQ ID mapping between the target cell and the source cell during cell switch in accordance with embodiments of the current invention.

FIG. 11 illustrates an exemplary flow chart of the UE performing partial MAC reset for cell switch by LTM in accordance with embodiments of the current invention.

FIG. 12 illustrates an exemplary flow chart of the UE keeping the HARQ process during the cell switch by LTM in accordance with embodiments of the current invention.

### DETAILED DESCRIPTION

Reference will now be made in detail to some embodiments of the invention, examples of which are illustrated in the accompanying drawings.

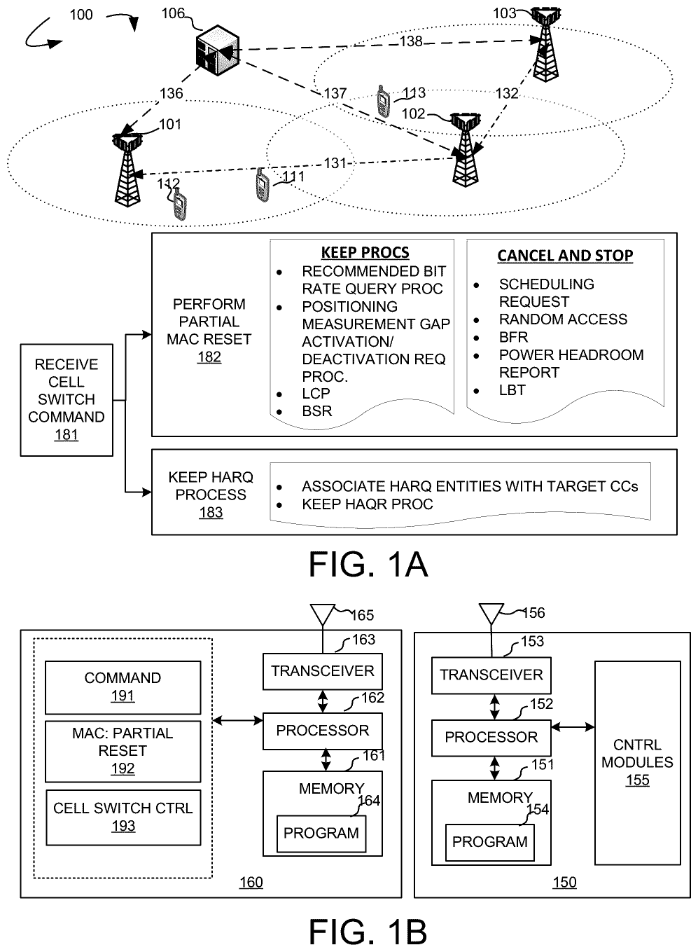

FIG. 1A is a schematic system diagram illustrating an exemplary wireless network with MAC partial reset during intra-DU LTM in accordance with embodiments of the current invention. Wireless system 100 includes one or more fixed base infrastructure units forming a network distributed over a geographical region. As an example, base stations/gNBs 101, 102, and 103 serve a number of mobile stations, such as UE 111, 112, and 113, within a serving area, for example, a cell, or within a cell sector. In some systems, one or more base stations are coupled to a controller forming an access network that is coupled to one or more core networks, through a network entity, such as network entity 106. gNB 101, gNB 102 and gNB 103 are base stations in NR, the serving area of which may or may not overlap with each other. As an example, UE or mobile station 112 is only in the service area of gNB 101 and connected with gNB 101. UE 112 is connected with gNB 101 only. UE 111 in the overlapping service area of gNB 101 and gNB 102 and may switch back and forth between gNB 101 and gNB 102. UE 113 in the overlapping service area of gNB 102 and gNB 103 and may switch back and forth between gNB 102 and gNB 103. Base stations, such as gNB 101, 102, and 103 are connected the network through network entities, such as network entity 106 through NG connections, such as 136, 137, and 138, respectively. Xn connections 131 and 132 connect the non-co-located receiving base units. Xn connection 131 connects gNB 101 and gNB 102. Xn connection 132 connects gNB 102 and gNB 103. These Xn/NG connections can be either ideal or non-ideal.

In one novel aspect, partial MAC reset is performed for intra-DU cell switch by LTM. In another novel aspect, the HARQ process is kept during the cell switch by LTM. At step 181, the UE receives cell switch command. In one novel aspect 182, partial MAC reset is performed by keeping a set of MAC procedures running during the cell switch procedure. In one embodiment, the set of MAC procedures comprises a logical channel prioritization procedure, a buffer status reporting procedure, a recommended bit rate query procedure, and a positioning measurement gap activation/deactivation request procedure. In another embodiment, partial MAC reset cancels and stops a set of MAC procedures including a scheduling request, a random access procedure, a beam failure recovery (BFR), consistent listen-before-talk (LBT) failure, and a power headroom reporting. In another novel aspect 183, the UE keeps the HARQ process during the cell switch by LTM. In one embodiment, the UE associates HARQ entities initiated by the source cell with target component carriers (CCs).

FIG. 1B illustrates an exemplary UE and base station for enhanced LTM procedures in accordance with embodiments of the current invention. Diagram 150 is an exemplary simplified block diagrams of a base station/gNB. The base station has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in the base station. Memory 151 stores program instructions and data 154 to control the operations of the base station. The base station also includes a set of control modules 155 that carry out functional tasks to communicate with mobile stations.

Diagram 160 illustrates simplified block diagrams of a mobile device/UE for enhanced LTM procedure. The UE has antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown) for different frequency bands transmitting and receiving. RF transceiver 163 also converts received baseband signals from processor 162, converts them to RF signals, and sends out to antenna 165. Processor 162 processes the received baseband signals and invokes different functional modules to perform features in the UE. Memory 161 stores program instructions and data 164 to control the operations of the UE. Antenna 165 sends uplink transmission and receives downlink transmissions to/from the base station.

The UE also includes a set of control modules that carry out functional tasks. These control modules can be implemented by circuits, software, firmware, or a combination of them. A command module 191 receives a cell switch command from the wireless network, wherein the cell switch command indicates a layer-1/layer-2 triggered mobility (LTM) to switch a UE serving cell from a source cell to a target cell. A partial reset module 192 performs a partial MAC reset for a cell switch procedure by LTM based on the cell switch command. According to some embodiments, the partial reset module 192 is implemented by MAC layer. A cell switch controller 193 switches the UE serving cell to the target cell upon a success of the cell switch procedure by LTM.

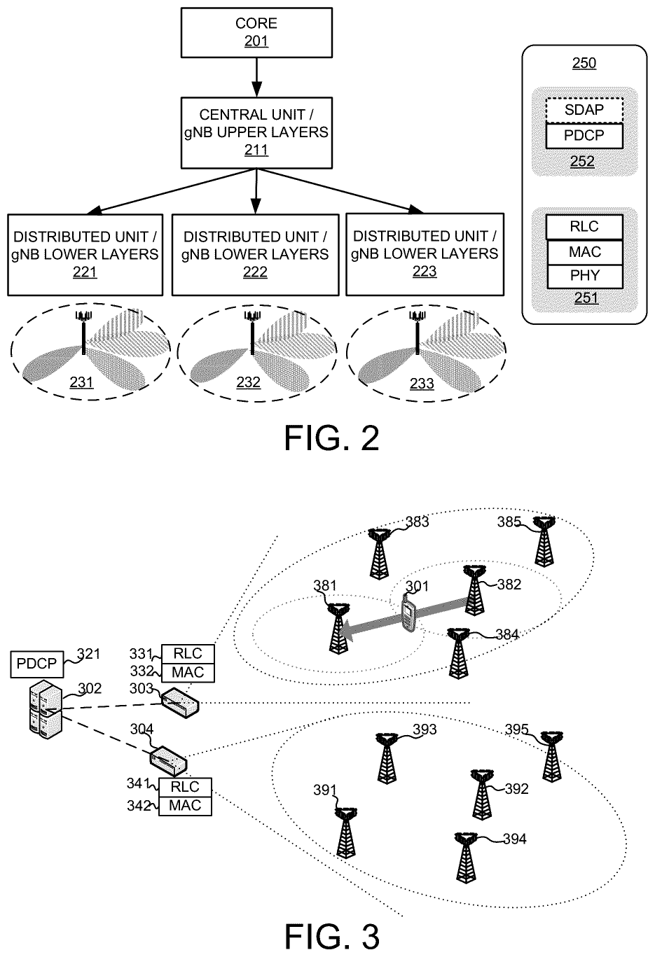

FIG. 2 illustrates an exemplary NR wireless system with centralized upper layers of the NR radio interface protocol stacks in accordance with embodiments of the current invention. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization and jitter. In one embodiment, SDAP and PDCP layer are located in the CU, while RLC, MAC and PHY layers are located in the DU. A core unit 201 is connected with one central unit 211 with gNB upper layer 252. In one embodiment 250, gNB upper layer 252 includes the PDCP layer and optionally the SDAP layer. Central unit 211 is connected with distributed units 221, 222, and 223. Distributed units 221, 222, and 223 each correspond to a cell 231, 232, and 233, respectively. The DUs, such as 221, 222 and 223 include gNB lower layers 251. In one embodiment 250, gNB lower layers 251 include the PHY, MAC and the RLC layers.

FIG. 3 illustrates an exemplary deployment scenario for intra-DU inter-cell LTM in accordance with the embodiments of the current invention. A CU 302 is connected to two DUs 303 and 304 through the F1 interface. CU 302 includes protocol stack PDCP 321. DU 303 includes protocol stack RLC 331 and MAC 332. DU 304 includes protocol stack RLC 341 and MAC 342. DU 303 and DU 304 are connected to multiple radio units (RUs) respectively. A cell may consist of a range covered by one or more RUs under the same DU. RUs/gNBs 381, 382, 383, 384, and 385 are connected with DU 303. RUs/gNBs 391, 392, 393, 394, and 395 are connected with DU 304. In this scenario, a UE 301 is moving from the edge of one cell served by gNB 382 to another cell served by gNB 381, which two belong to the same DU and share a common protocol stack. Enhanced LTM can be used in this scenario to replace the legacy handover process to reduce the interruption and improve the throughput and handover reliability in terms of handover failure rate of UE. In one embodiment, single protocol stack at the UE side (common RLC/MAC) is used to handle L1/L2 inter-cell beam management with mobility.

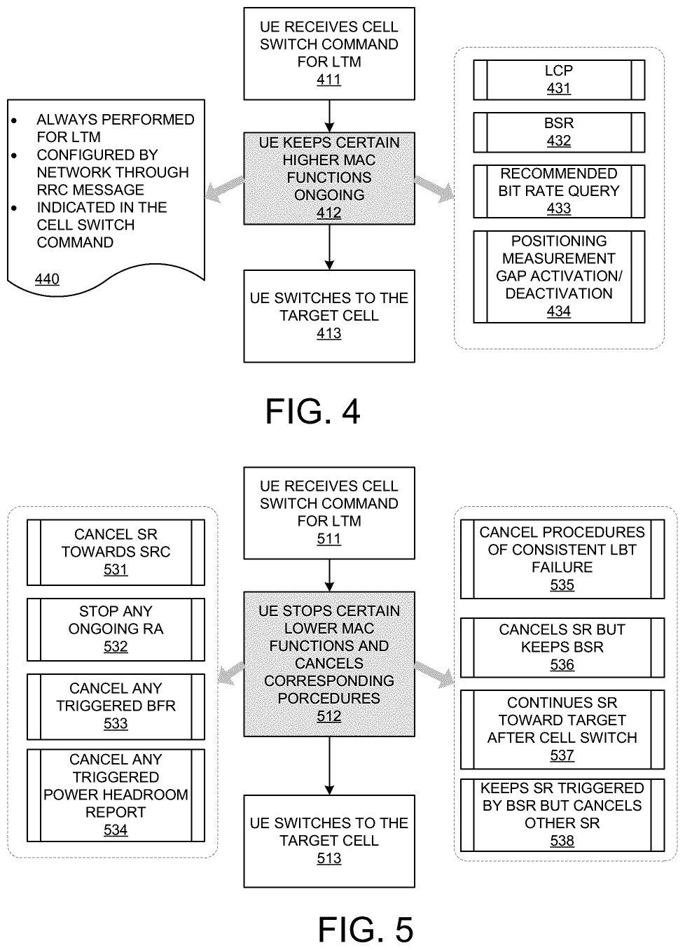

FIG. 4 illustrates exemplary diagrams of intra-DU cell switch during LTM for UE to keep certain MAC functions ongoing in accordance with embodiments of the current invention. At step 411, the UE receives the cell switch command for intra-DU LTM. In one embodiment, the radio link control (RLC) layer is not re-established during the cell switch. In one embodiment, the related procedures of the MAC functions providing services to the upper layer are maintained by UE during LTM. At step 412, the UE keeps certain MAC functions ongoing. In one embodiment 431, UE keeps the LCP (logical channel prioritization) procedure ongoing at MAC partial reset during LTM. In one embodiment 432, UE keeps the BSR (buffer status reporting) procedure ongoing at MAC partial reset during LTM. In one embodiment 433, UE keeps the recommended bit rate query procedure ongoing at MAC partial reset during LTM. In one embodiment 434, UE keeps the positioning measurement gap activation/deactivation request procedure ongoing at MAC partial reset during LTM. In embodiments 440, the partial MAC reset is always performed for the cell switch procedure by LTM or is triggered by configuration from the wireless network through radio resource control (RRC) message or is triggered by indication in the cell switch command. At step 413, the UE switches to the target cell.

FIG. 5 illustrates exemplary diagrams of intra-DU cell switch by LTM for the UE to stop certain MAC functions and cancels the corresponding procedures in accordance with embodiments of the current invention. At step 511, the UE receives the cell switch command for LTM. At step 512, the UE stops certain MAC functions and cancels the corresponding procedures. In one embodiment 531, UE cancels the scheduling request procedure toward the source cell. In one embodiment 532, UE stops the random access procedure at MAC partial reset. In one embodiment 533, UE cancels the procedures of BFR if triggered at MAC partial reset. In one embodiment 534, UE cancels the procedures of power headroom reporting at MAC partial reset. In one embodiment 535, UE cancels the procedures of consistent LBT failure if triggered at MAC partial reset. In one embodiment 536, UE cancels the scheduling request procedure but keeps the buffer status report procedures during LTM. In one embodiment 537, UE continues the scheduling request procedures toward target cell after the cell switch of LTM. In one embodiment 538, UE keeps the scheduling request procedure triggered by BSR but cancels other pending scheduling requests which are triggered by other purposes.

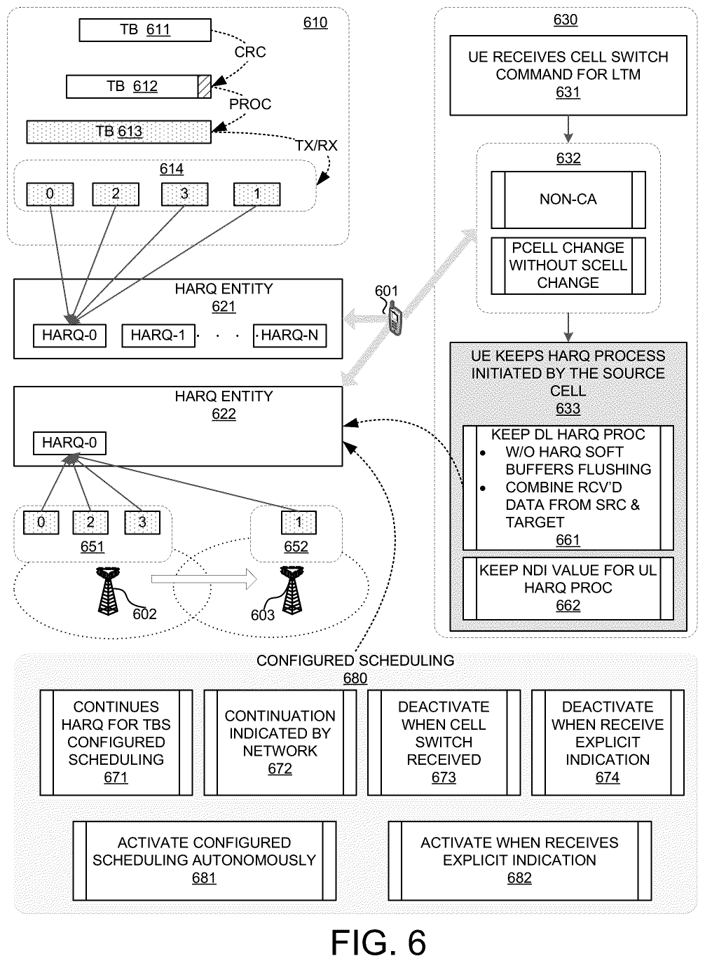

FIG. 6 illustrates exemplary diagrams for keeping the HARQ process for cell switch by LTM in non-CA scenario in accordance with embodiments of the current invention. In one novel aspect, the UE keeps the HARQ process at MAC reset during cell switch by LTM. The HARQ process is performed by dynamic scheduling or configured schedule. In one embodiment, the UE is configured with non-CA. Diagram 610 illustrates a dynamic configured HARQ where the UE associates code block/code block group (CB/CBG) of the same transport block (TB) with the same HARQ process. The exemplary transport block TB 611 goes through CRC attachment to TB 612, through channel coding, rate matching, etc. to TB 613. All the CB/CBGs 614 of the TB are associated with the same HARQ process, HARQ-0 of HARQ entity 621 of UE 601.

Diagram 630 illustrates an exemplary process of UE to associate the CB/CBG of the same TB from the source cell and target cell to the same HARQ process during LTM cell switch in the non-CA scenario in accordance with the embodiments of the current invention. At step 631, the UE receives cell switch for LTM. In one scenario 632, the UE configured with non-CA or when the UE is configured with CA, the cell switch changes the PCell without changing the SCell. At step 633, the UE keeps the HARQ process initiated by the source cell. In one embodiment, the source cell and target cell share the same MAC entity and HARQ entities on both the network side and the UE side. In one embodiment 661 for DL HARQ process, the received data for a TB from the source cell and the target cell is combined and the HARQ processes continued without HARQ soft buffers flushing at cell switch. Soft combining can be performed for the received data identified by the same HARQ ID before and after cell switch. An exemplary HARQ entity 622 initiates HARQ-0. The CB/CBGs of the same TB is transmitted by source gNB 602 of source data 651, and by target gNB 603 of target data 652 during LTM. UE 601 combines the received data 651 and 652 with the same HARQ buffer. In one embodiment, HARQ ID is explicitly indicated to UE by dynamic scheduling. In one embodiment 662 for UL HARQ process, UE keeps the new data indication (NDI) value of the HARQ process and doesn't initialize the NDI value of the HARQ process to zero. The embodiments are applicable to both dynamic scheduling and configured scheduling.

For configured scheduling 680, in one embodiment 671, the UE continues the HARQ processes for the TBs with configured scheduling in LTM. In one embodiment 672, whether to continue the HARQ processes for the TB with configured scheduling can be indicated by network through RRC message or MAC CE. In one embodiment 673, UE keeps the HARQ processes for the TBs with configured scheduling and deactivates configured scheduling upon reception of cell switch command. In one embodiment, UE deactivates configured scheduling autonomously upon reception of cell switch command. In one embodiment 674, UE deactivates configured scheduling when receiving the explicit indication from the network. In one embodiment, UE receives the explicit indication for configured scheduling deactivation in PDCCH. In another embodiment, UE receives the explicit indication for configured scheduling deactivation in MAC CE. In one embodiment, the deactivation indication is received before cell switch command. For configured scheduling, UE keeps configured scheduling in deactivation until the on-going HARQ processes initiated at the source cell are completed. The HARQ process is considered as completed if the TB is successfully received or the maximum number of the HARQ transmission is reached. After all the HARQ processes initiated at the source cell are completed, the configured scheduling can be activated. In one embodiment 681, UE activates the configured scheduling autonomously. In one embodiment 682, UE activates the configured scheduling when receiving the explicit indication from the network. In one embodiment, UE receives the explicit indication for configured scheduling activation in PDCCH.

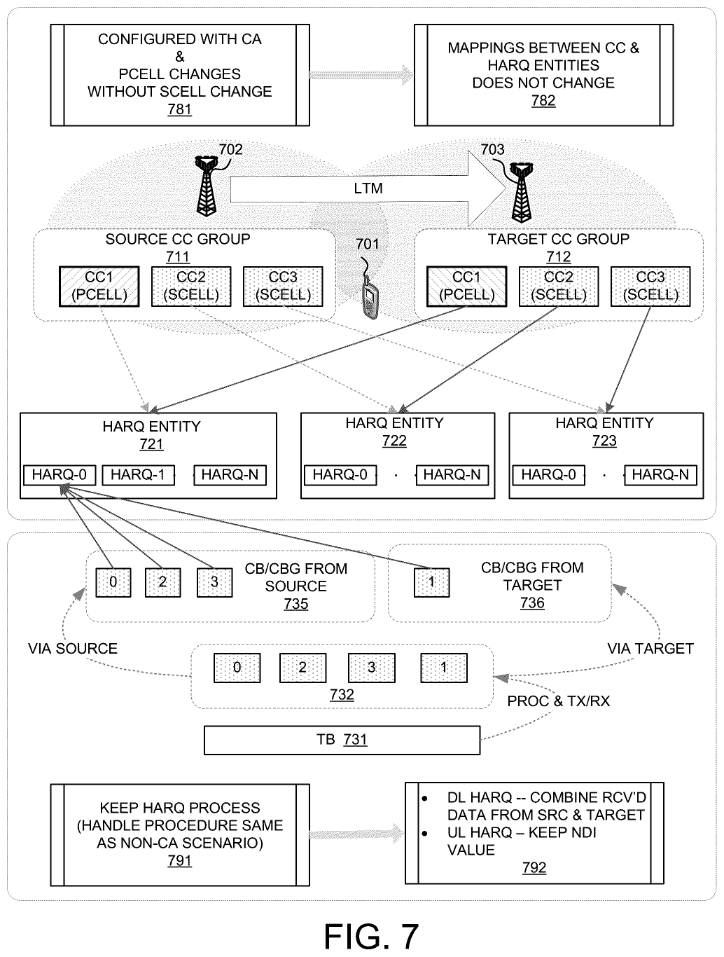

FIG. 7 illustrates exemplary diagrams for keeping the HARQ process for CA scenario of the cell switch when the PCell changes without SCell changes in accordance with embodiments of the current invention. In one scenario 781, the UE is configured CA and performs cell switch by LTM where PCell changes without SCell changes. In one embodiment 782, the mappings between CC and HARQ entities do not change after the cell switch. UE 701 is connected with gNB 702 in source cell configured source CC group 711, with PCell of CC1, and SCells of CC2 and CC3. As an example, CC1, CC2 and CC3 of source CC group 711 is mapped to HARQ entities 721, 722, and 723, respectively. In one embodiment, UE cell switches to gNB 703 and moves to target CC group 712, which has another PCell without SCell change. and the mapping between the component carrier and the HARQ entity does not change. CC1, CC2 and CC3 of target CC group 712 are mapped to HARQ entities 721, 722, and 723, respectively. In one embodiment, UE performs the HARQ handling procedure as the same as non-CA scenario. As an example, TB 731, after processing is received by CB/CBGs of 732. During cell switch, CB/CBGs 735 is received from the source cell and CB/CBGs 736 is received from the target cell. In one embodiment 791, the UE keeps the mapping and HARQ process for the cell switch by LTM. The CB/CBGs 735 and CB/CBGs 736 are all combined by HARQ-0 of HARQ entity 721. In one embodiments 792, the DL HARQ combines received from the source and target cell. The UL HARQ keeps the NDI value without resetting.

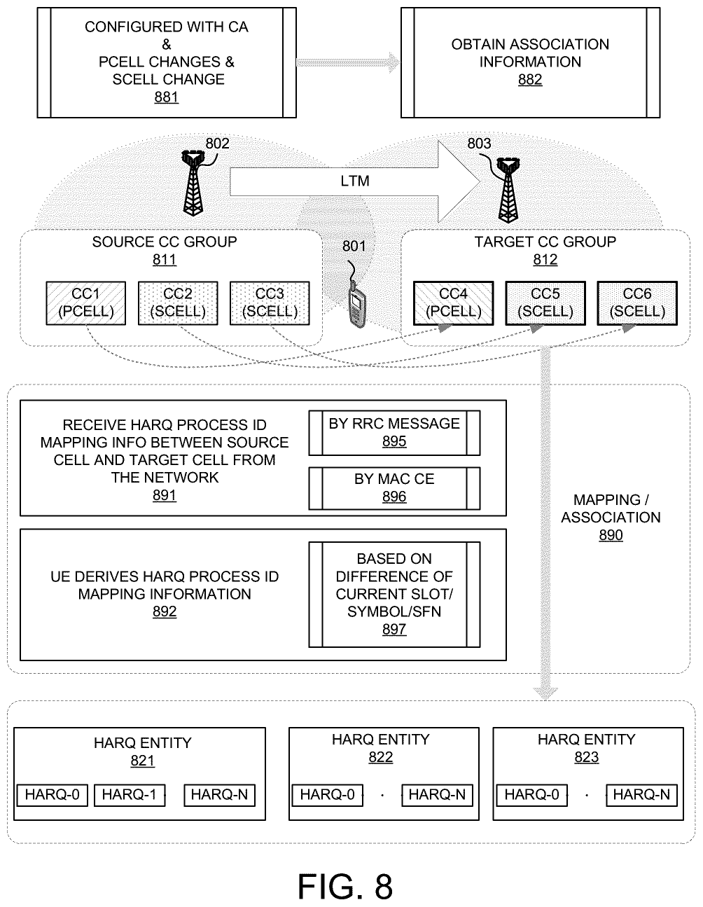

FIG. 8 illustrates exemplary diagrams for the UE to obtain association information in the CA scenario of the cell switch by LTM when the target PCell/target SCell (s) is not a current serving cell in accordance with embodiments. In one scenario 881, the UE is configured CA and performs cell switch by LTM where the target PCell and SCells is not a current serving cell. In one embodiment 882, UE 801 obtains association information. UE 801 is connected with gNB 802 in source cell configured source CC group 811, with PCell of CC1, and SCells of CC2 and CC3. As an example, CC1, CC2 and CC3 of source CC group 811 is mapped to HARQ entities 821, 822, and 823, respectively. After cell switch, the UE connected with gNB 803 and configured target cell group 812 with PCell CC4, and SCells CC5 and CC6. In one embodiment, the target cell (PCell/SCell) is not a current serving cell. For instance, the target PCell is a source Scell. In one embodiment, the component carriers changed, and the mapping between the component carriers and the HARQ entities changed. In one embodiment, the linkage between the component carriers of source cell group 811 and the component carriers of target cell group 812 is provided. In other words, the association information is the linkage between CCs of the source cell group and the target cell group. For example, CC1 in source cell group 811 is linked to CC4 in target cell group 812. CC2 in source cell group 811 is linked to CC5 in target cell group 812. CC3 in source cell group 811 is linked to CC6 in target cell group 812. Therefore, HARQ retransmission for the TBs on CC1 will be performed on CC4 associated with HARQ entity 821 after cell switch. HARQ retransmission for the TBs on CC2 will be performed on CC5 associated with HARQ entity 822 after cell switch. HARQ retransmission for the TBs on CC3 will be performed on CC6 associated with HARQ entity 823 after cell switch. In one embodiment 890, the UE maps the target CC to HARQ entities. In one embodiment 891, the UE receives the HARQ process ID mapping information between source cell and target cell from the network. In other words, the associate information is derived from the HARQ processes ID mapping information between the source cell and the target cell received from the wireless network. In one embodiment 895, the mapping information from the network is carried by RRC message. In one embodiment 896, UE receives the HARQ process ID mapping information between source cell and candidate cells by MAC CE message. In one embodiment 892, UE derives the HARQ process ID mapping information between source cell and target cell. In one embodiment 897, the UE derives the associate information, e.g., the HARQ process ID mapping information between the source cell and the target cell, based on the difference of current slot/symbol/subframe number (SFN).

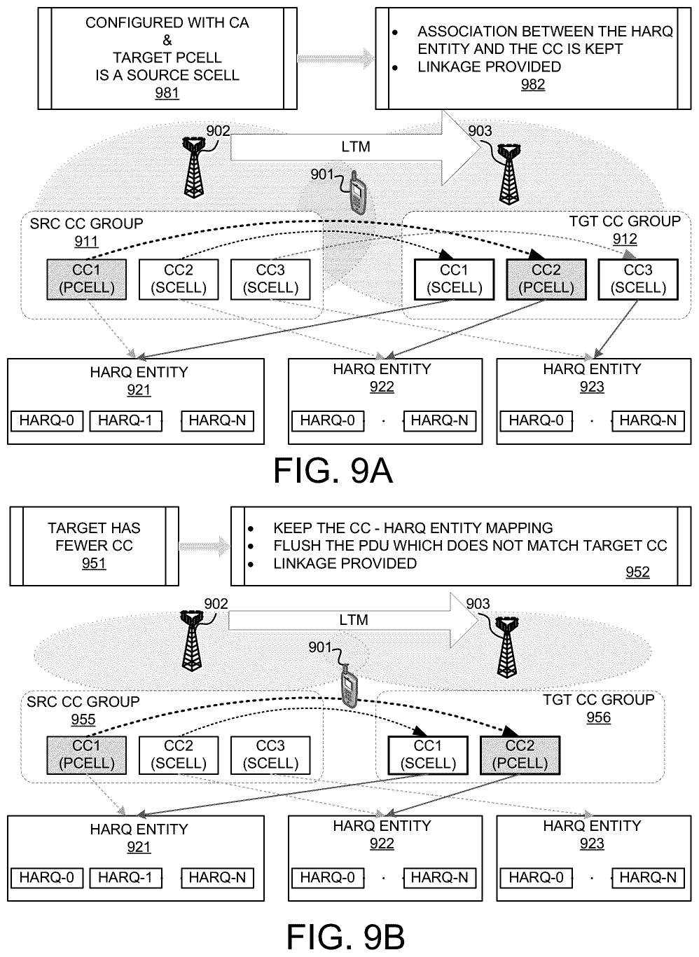

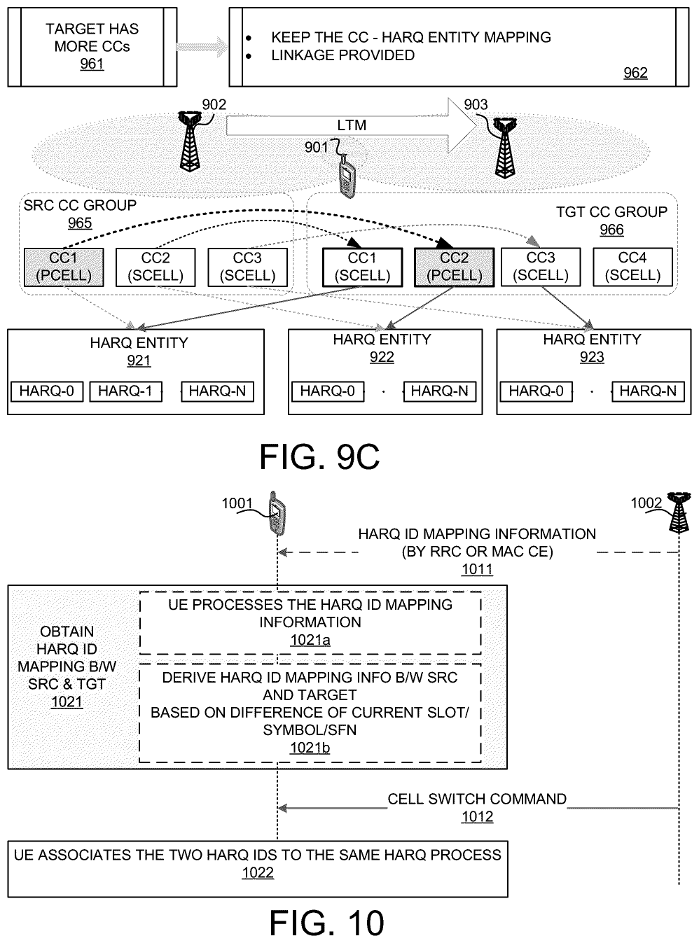

FIG. 9A illustrates exemplary diagrams of the UE keeps the CC and HARQ entity association in the CA scenario of the cell switch when the target PCell is a current SCell with equal component carriers in accordance with embodiments of the current invention. In one embodiment, the HARQ entity is associated to the physical component carrier. In one scenario 981, the UE is configured with CA and the target PCell is a current SCell with equal component carriers. In one embodiment 982, the association between the HARQ entity and the component carrier is kept and not reset even if the PCell and SCell role change or SCell index is changed. In one embodiment, the linkage between the component carriers of source cell group and the component carriers of target cell group is provided. UE 901 connected with source gNB 902 is configured with source CC group 911 with PCell of CC1, and SCells of CC2 and CC3. As an example, source CC1, CC2, and CC3 are associated with HARQ entities 921, 922, and 923, respectively. UE 901 performs cell switch by LTM to target gNB 903 and configured with target CC group 912. The target PCell is working on CC2, which is an SCell of the source cell. CC1 and CC3 are for target SCells. After the cell switch, the association between the CC and the HARQ entities are kept. The linkage between the source CCs and the target CCs is provided.

FIG. 9B illustrates exemplary diagrams of the UE keeps the CC and HARQ entity association in the CA scenario of the cell switch when the target PCell is a current SCell with fewer component carriers in the target cell in accordance with embodiments of the current invention. In one scenario 951, the UE is configured with CA and the target PCell is a current SCell with fewer component carriers. In one embodiment 952, the association between the HARQ entity and the component carrier is kept and not reset even if the PCell and SCell role change or SCell index is changed. In one embodiment, the linkage between the component carriers of source cell group and the component carriers of target cell group is provided. In one embodiment, the UE flushes the protocol data units (PDUs) for the component carrier which does not match with the target cell. As an example, UE 901 connected with source gNB 902 is configured with source CC group 955 with PCell of CC1, and SCells of CC2 and CC3. As an example, source CC1, CC2, and CC3 are associated with HARQ entities 921, 922, and 923, respectively. UE 901 performs cell switch by LTM to target gNB 903 and configured with target CC group 956. The target PCell is working on CC2, which is an SCell of the source cell. CC1 is for a target SCell. Target CC group 956 has fewer CCs than the source CC group 955. After the cell switch, the association between the CC and the HARQ entities are kept. CC1 and CC2 of target CC group 956 associate with HARQ entity 921 and 922, respectively. With fewer component carriers, some component carriers in the source cell may not get matched with the component carriers in the target cell, such as CC3 of source CC group 955. In one embodiment, the UE flushes the PDUs for the component carrier which does not match with the target cell.

FIG. 9C illustrates exemplary diagrams of the UE keeps the CC and HARQ entity association in the CA scenario of the cell switch when the target PCell is a current SCell with more component carriers in the target cell in accordance with embodiments of the current invention. In one scenario 961, the UE is configured with CA and the target PCell is a current SCell with more component carriers. In one embodiment 962, the association between the HARQ entity and the component carrier is kept and not reset even if the PCell and SCell role change or SCell index is changed. In one embodiment, the linkage between the component carriers of source cell group and the component carriers of target cell group is provided. As an example, UE 901 connected with source gNB 902 is configured with source CC group 965 with PCell of CC1, and SCells of CC2 and CC3. As an example, source CC1, CC2, and CC3 are associated with HARQ entities 921, 922, and 923, respectively. UE 901 performs cell switch by LTM to target gNB 903 and configured with target CC group 966. The target PCell is working on CC2, which is a SCell of the source cell. CC1, CC3, and CC4 are for target SCells. Target CC group 966 has more CCs than the source CC group 965. After the cell switch, the association between the CC and the HARQ entities are kept. CC1, CC2 and CC3 of target CC group 966 associate with HARQ entity 921, 922 and 923, respectively.

FIG. 10 illustrates an exemplary flow diagram for UE to perform HARQ ID mapping between the target cell and the source cell during cell switch in accordance with embodiments of the current invention. UE 1001 is connected with gNB 1002. In one embodiment, Configured scheduling is configured for UE. In one embodiment, HARQ ID mapping information for the HARQ entities in the source cell and the target cell is indicated by the network. At step 1011, the network/gNB 1002 indicates UE the HARQ process ID mapping information by RRC message or MAC CE. At step 1021, UE 1001 obtains the HARQ process ID mapping information between the source cell and the target cell. In one embodiment 1021a, the network indicates UE the HARQ process ID mapping information by RRC message or MAC CE. UE 1001 processes the HARQ ID mapping information and obtains the HARQ process ID mapping information between the source cell and the target cell. In one embodiment 1021b, the UE derives the HARQ process ID mapping information between the source cell and the target cell based on the difference of current slot/symbol/SFN. At step 1012, the UE receives cell switch command. At step 1022, the UE associates the two HARQ process IDs to the same HARQ process of HARQ entity. In one embodiment, the network ensures the HARQ processes from source cell and target cell can be mapped to the same HARQ ID.

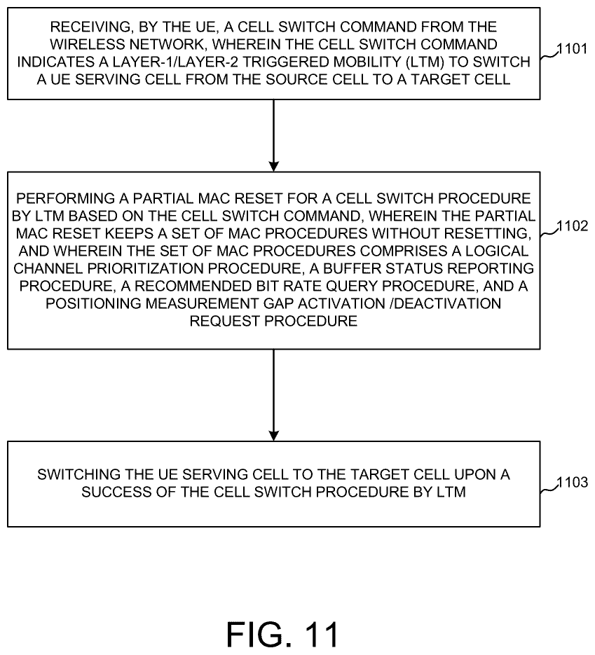

FIG. 11 illustrates an exemplary flow chart of the UE performing partial MAC reset for cell switch by LTM in accordance with embodiments of the current invention. At step 1101, the UE receives a cell switch command from the wireless network, wherein the cell switch command indicates a layer-1/layer-2 triggered mobility (LTM) to switch a UE serving cell from the source cell to a target cell. At step 1102, the UE performs a partial MAC reset for a cell switch procedure by LTM based on the cell switch command, wherein the partial MAC reset keeps a set of MAC procedures without resetting, and wherein the set of MAC procedures comprises a logical channel prioritization procedure, a buffer status reporting procedure, a recommended bit rate query procedure, and a positioning measurement gap activation/deactivation request procedure. At step 1103, the UE switches the UE serving cell to the target cell upon a success of the cell switch procedure by LTM.

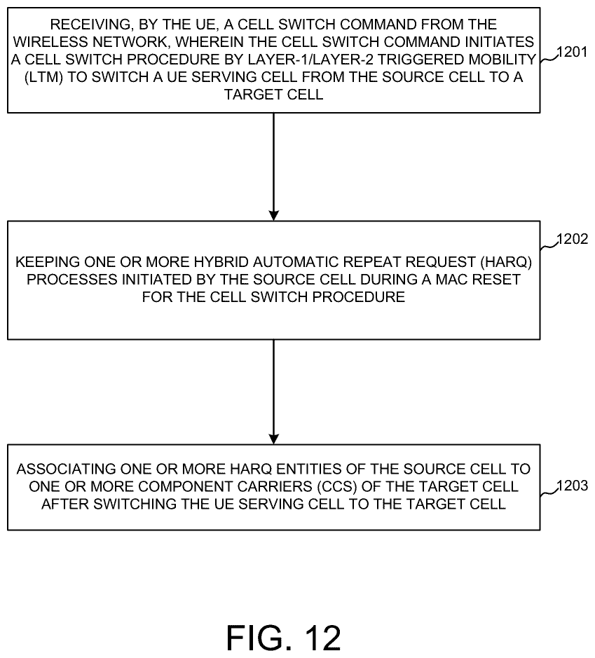

FIG. 12 illustrates an exemplary flow chart of the UE keeping the HARQ process during the cell switch by LTM in accordance with embodiments of the current invention. At step 1201, the UE receives a cell switch command from the wireless network, wherein the cell switch command initiates a cell switch procedure by layer-1/layer-2 triggered mobility (LTM) to switch a UE serving cell from the source cell to a target cell. At step 1202, the UE keeps one or more Hybrid Automatic Repeat Request (HARQ) processes initiated by the source cell during a MAC reset for the cell switch procedure. At step 1203, the UE associates one or more HARQ entities of the source cell to one or more component carriers (CCs) of the target cell after switching the UE serving cell to the target cell.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE) connected with a source distributed unit (DU) of a source cell in a wireless network, comprising:
receiving, by the UE, a cell switch command from the wireless network, wherein the cell switch command indicates a layer-1/layer-2 triggered mobility (LTM) to switch a UE serving cell from the source cell to a target cell;
performing a partial MAC reset for a cell switch procedure by LTM based on the cell switch command, wherein the partial MAC reset keeps a set of MAC procedures without resetting, and wherein the set of MAC procedures comprises a logical channel prioritization procedure, a buffer status reporting procedure, a recommended bit rate query procedure, and a positioning measurement gap activation/deactivation request procedure; and
switching the UE serving cell to the target cell upon a success of the cell switch procedure by LTM.

2. The method of claim 1, wherein the cell switch procedure by LTM is for an intra-DU cell switch.

3. The method of claim 1, wherein the partial MAC reset is always performed for the cell switch procedure by LTM, triggered by configuration from the wireless network through radio resource control (RRC) message, or triggered by indication in the cell switch command.

4. The method of claim 1, wherein the partial MAC rest further comprising stopping an ongoing random access procedure, canceling triggered procedures of a power headroom reporting, canceling triggered beam failure recovery (BFR) procedures, canceling consistent listen-before-talk (LBT) failure procedures.

5. The method of claim 1, wherein the partial MAC reset further comprising stopping a scheduling request (SR) procedure towards the source cell.

6. The method of claim 5, further comprising triggering an SR procedure by a pending BSR procedure toward the target cell when the UE switches to the target cell.

7. A method for a user equipment (UE) connected with a source cell in a wireless network, comprising:
receiving, by the UE, a cell switch command from the wireless network, wherein the cell switch command initiates a cell switch procedure by layer-1/layer-2 triggered mobility (LTM) to switch a UE serving cell from the source cell to a target cell;
keeping one or more Hybrid Automatic Repeat Request (HARQ) processes initiated by the source cell during a MAC reset for the cell switch procedure; and
associating one or more HARQ entities of the source cell to one or more component carriers (CCs) of the target cell after switching the UE serving cell to the target cell.

8. The method of claim 7, wherein a code block/code block group (CB/CBG) of a same transport block (TB) from the source cell and the target cell are associated to a same HARQ process when the UE is configured non-carrier aggregation (non-CA) or when CA is configured and Pcell change while there is no secondary cell (SCell) change for the cell switch procedure.

9. The method of claim 7, wherein a TB received from the source cell and the target cell is combined for downlink (DL) HARQ process and no HARQ soft buffer flushing during the cell switch procedure.

10. The method of claim 7, wherein the UE keeps a value of new data indication (NDI) of an uplink (UL) HARQ process during the cell switch procedure.

11. The method of claim 7, wherein the UE deactivates a configured scheduling of the one or more HARQ processes for the cell switch procedure upon detecting at least one conditions comprising reception of the cell switch command, an explicit indication for configured scheduling deactivation in a physical downlink control channel (PDCCH) or in a MAC control element (CE).

12. The method of claim 7, further comprising obtaining association information to associate the one or more HARQ entities of the source cell to one or more CCs of the target cell, and wherein CA is configured for the UE with a source primary cell (PCell) and one or more source secondary cells (SCells) for a source cell group and the target cell is configured with a target PCell and one or more target SCells for a target cell group.

13. The method of claim 12, wherein the association information is the linkage between CCs of the source cell group and the target cell group when the target PCell is a source SCell, and wherein the UE associates one or more HARQ entities to corresponding target CCs based on the linkage.

14. The method of claim 12, wherein the associate information is derived from the HARQ processes ID mapping information between the source cell and the target cell received from the wireless network.

15. The method of claim 14, wherein the HARQ process ID mapping information is received by a radio resource control (RRC) message or a MAC control element (CE).

16. The method of claim 12, wherein the UE derives the association information based on the difference of current slot/symbol/SFN.

17. The method of claim 7, wherein the one or more HARQ processes are performed by a dynamic scheduling or a configured scheduling.

18. A user equipment (UE), comprising:
a transceiver that transmits and receives radio frequency (RF) signal in a wireless network;
a command module that receives a cell switch command from the wireless network, wherein the cell switch command indicates a layer-1/layer-2 triggered mobility (LTM) to switch a UE serving cell from a source cell to a target cell;
a partial reset module that performs a partial MAC reset for a cell switch procedure by LTM based on the cell switch command; and
a cell switch controller that switches the UE serving cell to the target cell upon a success of the cell switch procedure by LTM.

19. The UE of claim 18, wherein the partial reset keeps a set of MAC procedures without resetting, and wherein the set of MAC procedures comprises a logical channel prioritization procedure, a buffer status reporting procedure, a recommended bit rate query procedure, and a positioning measurement gap activation/deactivation request procedure.

20. The UE of claim 18, wherein the partial MAC reset keeps one or more Hybrid Automatic Repeat Request (HARQ) processes initiated by the source cell for the cell switch procedure.
